(19) United States
(12) Patent Application Publication
(10) Pub. No.: US 2015/0213502 A1
(43) Pub. Date: Jul. 30, 2015

(54) Method and System for Individually Targeting Advertisements Played on Output Devices Based on Personalities of Present Mobile Devices

(71) Applicants: David D. Minter, Littleton, CO (US); Albert S. Baldocchi, Boulder, CO (US); Jeffrey D. Minter, Littleton, CO (US)

(72) Inventors: David D. Minter, Littleton, CO (US); Albert S. Baldocchi, Boulder, CO (US); Jeffrey D. Minter, Littleton, CO (US)

(21) Appl. No.: 14/166,392

(22) Filed: Jan. 28, 2014

(51) Int. Cl. G06Q 30/02; H04L 29/06; H04W 4/04; H04W 4/00

(52) U.S. Cl. CPC G06Q 30/0267; H04W 4/008; H04L 65/601; H04W 4/043

(57) ABSTRACT

A method and system for individually targeted advertising targets advertisements played on output devices based on compatibility of the ads with the behaviorally determined personalities of mobile devices whose presence is detected near the output devices. The behaviorally determined mobile device personalities used in ad targeting reflect the preferences, interests and habits of the individuals who use the mobile devices and are exposed to the ads, yet may be determined and applied by the system transparently to these individuals. In some embodiments, the personalities are linked with unique mobile advertising identifier (MAIs) of the mobile devices transferred from the mobile devices to presence sensors associated with the output devices when the mobile devices are present near the output devices, whereafter the personalities are accessed using the MAIs and applied in ad selection.

### BACKGROUND OF THE INVENTION

The present invention relates to individually targeted advertising.

Most advertisements are delivered with little knowledge of the individual preferences, interests or habits of the people who receive them. Instead, most ads are targeted, if at all, to demographic groups made up of large numbers of individuals whose preferences, interests and habits often diverge. Thus, a beer company may advertise during a professional football game knowing that NFL fans generally speaking like beer. However, while many (perhaps even most) NFL fans like beer, some do not. The NFL fans who don't like beer are likely to be impervious to, and possibly even annoyed by, beer ads that run during a game. Indeed, some of these fans may be wine drinkers who might be influenced to purchase in response to a different ad from a wine concern.

In short, the more precise advertisers are in targeting their ads, the better those ads work. Yet demographically targeted ads are often not very precise.

Meanwhile, recent advances have been made in individually targeting advertisements to roaming consumers based on the location of their mobile devices. However, these systems have several shortcomings.

First, these systems generally require proximity between the individual's mobile device and a merchant establishment where the product or service being advertised is sold as a condition for receiving the advertisement. In an exemplary system, when a mobile device user walks through a retail store carrying the mobile device (e.g., smart phone), an ad for merchandise sold in the store plays on the mobile device. The ad may be triggered, for example, by a barcode image captured or scanned by the mobile device, Near Field Communication (NFC) contact between the mobile device and a merchant device, or wireless communication, such as IEEE 802.11 (Wi-Fi), Bluetooth or Radio Frequency Identification (RFID) communication, between the mobile device and a merchant device. Such a system requires that the individual travel to the retail store where the advertised merchandise is being sold in order to receive the ad.

Second, these systems typically play the advertisement on the individual's mobile device. The individual may consider this a nuisance and even an invasion of privacy. Moreover, the ad may be played in a manner highly disruptive to entertainment content being enjoyed on the mobile device by the individual, such a song being listened to or a video being watched.

Third, some of these systems require that the individual take action to receive or play the advertisement (e.g., by imaging a barcode, making NFC contact or clicking an “accept” or “play now” button on the mobile device). The requirement to affirmatively act may be a sufficient deterrent that the individual declines to receive or play the ad even though it might have been of interest.

Fourth, in systems where the individual is not required to act to receive or play the advertisement, there is often no mechanism to verify that the ad comports with the individual's preferences or interests before it is played. Moreover, even in systems where such a mechanism exists, the individual must often configure the mechanism on the mobile device by inputting his or her preferences or interests or revealing his or her personal identity to the system, which may discourage the individual from using these systems.

Fifth, these systems often lack a way to intelligently prioritize or sequence incoming advertisements from different sources that interfere with one another.

### SUMMARY OF THE INVENTION

It is an object of the present invention to provide an individually targeted advertising system where proximity between the individual's mobile device and a merchant establishment where the product or service being advertised is sold is permitted, but not required, as a condition for receiving the advertisement.

It is another object of the invention to provide an individually targeted advertising system that does not play the advertisement on the individual's mobile device.

It is another object of the invention to provide an individually targeted advertising system that does not play the advertisement in a manner that is highly disruptive of entertainment content being enjoyed by the individual.

It is another object of the invention to provide an individually targeted advertising system that does not require the individual to take action to receive or play the advertisement.

It is another object of the invention to provide an individually targeted advertising system which verifies that the advertisement comports with preferences or interests of an individual who will receive the ad before playing it.

It is another object of the invention to provide an individually targeted advertising system that does not require the individual to configure his or her preferences or interests through user input on his or her mobile device.

It is another object of the invention to provide an individually targeted advertising system that does not require the individual to reveal his or her personal identity to the system.

It is another object of the invention to provide an individually targeted advertising system that intelligently blends, prioritizes or sequences incoming advertisements from different sources that interfere with one another.

These and other objects of the invention are achieved by a system for individually targeted advertising that targets advertisements played on output devices based on compatibility of the ads with behaviorally determined personalities of mobile devices whose presence is detected near the output devices. The behaviorally determined mobile device personalities used by the system in ad targeting reflect the preferences, interests and habits of the individuals who use the mobile devices and thus are exposed to the ads, yet may be determined and applied without requiring these individuals to configure their preferences or interests or using their personal identities. Moreover, the system permits, but does not require, proximity between the mobile devices and a merchant establishment where the products and services being advertised are sold as a condition for receiving the ads; does not play the ads on the mobile devices; does not play the ads in a manner that is highly disruptive of entertainment content being enjoyed by the individuals; and does not require the individuals to take action to receive or play the ads.

In an exemplary embodiment, the system determines a personality of a mobile device through behavioral study. The system acquires from one or more sources behavioral data linked with a unique mobile advertising identifier (MAI) assigned to the mobile device and determines a personality of the mobile device using the behavioral data. The system stores the personality in association with the MAI. The personality determination may be conducted transparently to the individual who uses the mobile device, that is, it does not require intervention or even awareness on the part of the individual and does not use the individual's personal identity. The system thereafter detects presence of the mobile device near an output device at a public or private space. The mobile device transfers the MAI from the mobile device to a presence sensor on or near the output device while the mobile device is present near the output device. The system then selects one or more advertisements compatible with the personality of the mobile device. The system accesses the personality of the mobile device using the MAI and selects ads compatible with the personality. The system then plays the ads on the output device. As with the personality determination, presence detection and ad selection may be conducted transparently to the mobile device user.

The system may acquire state information from the mobile device upon detecting presence of the mobile device at or near the output device and use the state information along with the personality in advertisement selection.

The system may insert the selected advertisements at a program break in an entertainment program being played on the output device.

If the system detects concurrent presence near the output device of multiple mobile devices whose personalities are known, the system may select advertisements compatible with the personalities of these mobile devices by selecting a sequence of ads compatible with the personalities of individual ones of the mobile devices selected in a round-robin sequence; or by selecting ads compatible with a composite personality determined by blending the personalities of the mobile devices; or by selecting ads compatible with a personality of one of the mobile devices having a highest priority.

The invention also provides a related method.

The invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows a mobile device personality determination subsystem within a system for individually targeted advertising.

FIG. 2 shows an advertisement selection and output subsystem within a system for individually targeted advertising in a first embodiment of the invention.

FIG. 3 shows an output device within a system for individually targeted advertising in the first embodiment.

FIG. 4 shows an advertisement selection and output subsystem in a second embodiment of the invention.

FIG. 5 shows an advertisement selection and output subsystem in a third embodiment of the invention.

FIG. 6 shows an advertisement selection and output subsystem in a fourth embodiment of the invention.

FIG. 7 shows an advertisement selection and output subsystem in a fifth embodiment of the invention.

FIG. 8 shows a method for individually targeted advertising.

FIG. 9 shows a round-robin method for selecting advertisements during a period of concurrent presence of mobile devices in an output device coverage area.

FIG. 10 shows a blending method for selecting advertisements during a period of concurrent presence of mobile devices in an output device coverage area.

FIG. 11 shows a priority-based method for selecting advertisements during a period of concurrent presence of mobile devices in an output device coverage area.

### DETAILED DESCRIPTION OF A PREFERRED EMBODIMENT

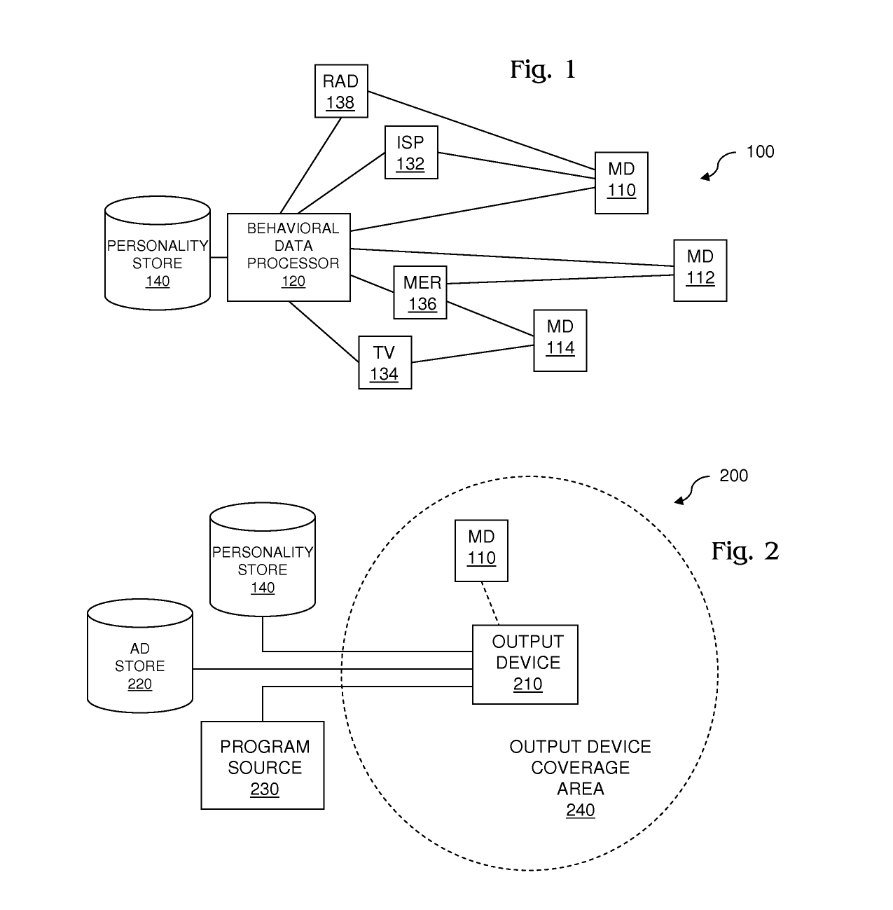

FIG. 1 shows a mobile device personality determination subsystem 100 within a system for individually targeted advertising. Subsystem 100 includes mobile devices (MDs) 110, 112, 114 and a behavioral data processor 120 that determines the personalities of mobile devices 110, 112, 114.

Mobile devices 110, 112, 114 are Internet capable devices that often accompany their users as these individuals perform daily activities. By way of example, mobile devices 110, 112, 114 may include portable computing devices such as smart phones, tablet computers, notebook computers, e-readers, personal data assistants, smart watches and/or smart glasses. Mobile devices 110, 112, 114 may also include Internet capable passenger vehicles, such as cars or airplanes. Each of mobile devices 110, 112, 114 has assigned thereto a unique mobile advertising identifier (MAI) capable of distinguishing the mobile device from other devices in the individually targeted advertising system. MAIs are digital identifiers that in some embodiments are stored in nonvolatile memory on mobile devices 110, 112, 114. In some embodiments, MAIs are special purpose identifiers dedicated for use in the individually targeted advertising system. Dedicated MAIs are advantageous in allowing mobile devices whose presence is detected by the system to be readily recognized as having a known personality. However, in other embodiments, MAIs are multipurpose identifiers that are used in the individually targeted advertising system as well as other applications. A multipurpose MAI may be, for example, a manufacturer's serial number, international mobile station equipment identity (IMEI), integrated circuit card identifier, international mobile subscriber identity (IMSI), subscriber identity module (SIM) card number, media access control (MAC) address or Bluetooth device address.

Behavioral data processor 120 collects behavioral data linked with MAIs, determines personalities of mobile devices 110, 112, 114 using the behavioral data and stores the personalities in association with MAIs in a personality store 140. In some embodiments, behavioral data processor 120 determines the personalities of mobile devices 110, 112, 114 transparently to the users of mobile devices 110, 112, 114. In these embodiments, personality determinations are made without user intervention and without using personal identities of the users.

Behavioral data processor 120 may collect behavioral data about mobile devices 110, 112, 114 from various sources. As mobile devices 110, 112, 114 interact with other network devices, mobile devices 110, 112, 114 store behavioral information internal memory and also leave a “trail” of behavioral information on the other network devices. Accordingly, one source of behavioral information is the mobile devices 110, 112, 114 themselves. Other sources may include, without limitation, databases of Internet service providers (ISP) 132 from which mobile devices 110, 112, 114 receive Internet services; databases of cable, satellite and Internet television providers (TV) 134 from which mobile devices 110, 112, 114 receive television services; databases of online and bricks-and-mortar merchants (MER) 136 with which mobile devices 110, 112, 114 transact; and databases of satellite and Internet radio providers (RAD) 138 from which mobile devices 110, 112, 114 receive radio services. These behavioral data sources are merely exemplary; other behavioral data sources may include, for example, databases of Internet search providers and advertising agencies. Processor 120 may collect behavioral data periodically, episodically, or both.

Behavioral data collected by behavioral data processor 120 includes various types of information indicating or suggesting preferences, interests and habits of the users of mobile devices 110, 112, 114. Behavioral data processor 120 identifies behavioral data as relating to mobile devices 110, 112, 114 based on MAIs linked with behavioral data at the sources from which processor 120 obtains the data. Behavioral data may include information about, for example, physical locations visited (e.g., cities, roads, stores, workplaces, etc.), websites visited, products and services purchased, political and charitable contributions made, web searches conducted, television stations and programs viewed, radio stations and programs listened to, video games played, hardware platforms used (e.g. smart phone, tablet computer, game system, etc.) and software applications and utilities used. Behavioral data may also include associated date and time of use information.

Behavioral data processor 120 determines personalities of mobile devices 110, 112, 114 algorithmically using collected behavioral data. Behavioral data processor 120 identifies preferences, interests and habits of mobile devices 110, 112, 114 from patterns and trends witnessed in the collected behavioral data and generates personality data sets reflecting the patterns and trends. Personality data sets may include, by way of example, interest or preference scores for various subject categories, such as art, cooking, crafts, collectibles, computing, dieting, dining, exercise, fashion, food, furniture, gardening, history, home improvement, language, literature, movies, music, politics, science, sports, technology, television and travel. For greater granularity, subject categories may be divided into subcategories that address, for example, specific topics, merchants and organizations, and individuals within subject categories. For example, in the sports category, topics may include baseball, basketball, football, hockey and soccer; merchants and organizations may include Sports Authority and Dick's; and individuals may include Lebron James and Peyton Manning. Behavioral data processor 120 stores the personalities of mobile devices 110, 112, 114 in personality store 140 in association with their corresponding MAIs.

In some embodiments, behavioral data collected and used in determining personalities of mobile devices 110, 112, 114 also includes the advertisements selected using the personalities. For example, selected ads may be compared with the purchase histories of mobile devices 110, 112, 114 shortly after their users are exposed to the ads to assess the effectiveness of the ads and modify personalities of mobile devices 110, 112, 114 accordingly.

Naturally, the cadre of mobile devices 110, 112, 114 and behavioral data sources 132, 134, 136, 138 shown in FIG. 1 is merely exemplary. The number and type of mobile devices whose personalities are determined by subsystem 100 and the number and type of behavioral data sources in subsystem 100 may vary. Subsystem 100 may also have more than one behavioral data processor or personality store. Behavioral data processors and personality stores may even reside and operate on mobile devices which determine and store their own personalities.

Turning to FIG. 2, an advertisement selection and output subsystem 200 within the system for individually targeted advertising is illustrated in a first embodiment. Subsystem 200 includes an output device 210 that remotely communicates with personality store 140, an advertisement store 220 and a program source 230. Output device 210 plays advertisements selected based on their compatibility with the personality of mobile device 110 whose presence is detected in output device coverage area 240. Output device 210 locally acquires from mobile device 110 its unique MAI and information on the state of mobile device 110. Output device 210 uses the MAI as a lookup key to remotely access the personality of mobile device 110 stored in personality store 140. Output device 210 then remotely accesses advertisement store 220, selects one or more advertisements based on compatibility of the ads with the personality and state information acquired from mobile device 110 and plays the ads on output device 210. The ads are played during program breaks in an entertainment program sourced by program source 230 and played on output device 210. As with personality determination, ad selection and output may be conducted transparently to any user of mobile device 110.

Output device 210 is an Internet capable device having an output interface and is resident at a public or private location. By way of example, output device 210 may be a television set; radio player; digital sign (e.g., electronic billboard); movie theater screen; or desktop computer. Output device 210 may be located, for example, in a public or private building, such as an airport, bar, bus station, corporate lobby, hotel elevator or lobby, restaurant, retail store, shopping mall or train station; at roadside; in a passenger vehicle used by the public or private individuals for transit, such as an airplane, bus, car, ship or taxi; or in a personal residence.

Output device coverage area 240 is a defined area surrounding output device 210 where audio and/or visual output played on output device 210 is deemed likely to be effectively received. The extent of output device coverage area 240 may be defined in relation to physical barriers such as building walls, a car frame or another type of partition that blocks sound or sight lines; and may be further defined to minimize interference with output from other output devices.

Referring to FIG. 3, output device 210 is shown in more detail to include a presence sensor 310, an advertising manager 320 and an output interface 330. Presence sensor 310 is a proximity detection device that detects presence of mobile device 110 in output device coverage area 240. Presence sensor 310 locally acquires the MAI from mobile device 110 by transfer of the MAI to presence sensor 310 when mobile device 110 is within output device coverage area 240. If necessary, presence sensor 310 performs distance verification to determine that mobile device 110 is within output device coverage area 240.

Presence of mobile device 110 within output device coverage area 240 may be detected using various acoustic, optical or wireless networking indoor positioning system (IPS) or outdoor positioning system (OPS) methodologies for detecting local presence.

In some embodiments, presence sensor 310 is a wireless networking device that through wireless communication with mobile device 110 acquires the MAI of mobile device 110 as well as a signal strength indication of the communication. For example, presence sensor 310 may be a Bluetooth networking device that automatically establishes wireless communication with mobile device 110 and acquires the Bluetooth device address of mobile device 110 and a received signal strength indication (RSSI) of the Bluetooth communication. As another example, presence sensor 310 may be an Wi-Fi access point that automatically establishes communication over wireless with mobile device 110 and acquires the MAC address of mobile device 110 and a RSSI of the Wi-Fi communication. Regardless of how a signal strength indication is acquired, presence sensor 310 uses the signal strength indication to compute the distance of mobile device 110 from output device 120 and confirm that mobile device 110 is within output device coverage area 240.

In other embodiments, presence sensor 310 is a wireless networking device that through wireless communication with mobile device 110 acquires the MAI and an explicit geolocation of mobile device 110 such as latitude and longitude coordinates. For example, presence sensor 310 may be a Bluetooth or Wi-Fi networking device that automatically establishes wireless communication with mobile device 110 and acquires a Bluetooth device address or MAC address as well latitude and longitude coordinates for mobile device 110 acquired by the mobile device 110 using a global positioning system (GPS) receiver or through base station triangulation. Presence sensor 310 uses the explicit geolocation of mobile device 110 and the known geolocation of output device 120 to compute the distance between mobile device 110 and output device 120 and thereby confirm that mobile device 110 is within output device coverage area 240.

In still other embodiments, presence sensor 310 may verify that mobile device 110 is within output device coverage area 240 by other means, such as optical or acoustic sensing. For example, output device 120 may determine the distance between mobile device 110 and output device 120 by reference to a light or sound signal (e.g., light pulse or ultrasonic sound) emitted by mobile device 110. Distance verification through optical or acoustic sensing may be particularly useful in a personal residence where the output device coverage area is a specific room of a house or apartment bounded by walls, a floor and a ceiling (e.g., a family room having a television set).

The MAI of mobile device 110 may be transferred from mobile device 110 to presence sensor 310 before or after distance verification, depending on implementation. Moreover, distance verification may not be necessary in certain cases, such as where presence is detected through physical contact between mobile device 110 and presence sensor 310.

Upon confirming that mobile device 110 is within output device coverage area 240, presence sensor 310 relays the MAI of mobile device 110 (e.g. Bluetooth device address or MAC address) to advertising manager 320 for further processing.

Advertising manager 320 is a processing element that uses the MAI of mobile device 110 acquired from presence sensor 310 to select one or more advertisements compatible with the remotely accessed personality of mobile device 110 and state information locally acquired from mobile device 110. When advertising manager 320 receives the MAI of mobile device 110 from presence sensor 310, advertising manager 320 uses the MAI to establish communication over wireless with mobile device 110 and acquire from mobile device 110 state information stored on mobile device 110. State information may include various types of information indicating the present or recent operating state of mobile device 110 and the surrounding environment that may influence advertisement selection. State information may include, for example, GPS coordinates of recently visited locations, uniform resource locators (URLs) of presently and recently visited websites, web cookies and records of recently completed purchases. In addition to acquiring state information, advertising manager 320 uses the MAI as a lookup key to remotely access the personality of mobile device 110 from personality store 140. Once the personality and state information have been acquired, advertising manager 320 select ads compatible with the personality and state information and remotely accesses advertisement store 220 to retrieve the selected ads.

The compatibility of advertisements stored in advertisement store 220 with the personality and state information of mobile device 110 is determined by advertising manager 320 through execution of an algorithm that computes the match quality between different advertisements, on the one hand, and the personality and state information of mobile device 110, on the other. As one example, match quality for a given advertisement may be computed based on overall conformity between relevancy scores for the ad in numerous subject categories with interest or preference scores in those categories reflected in the personality of mobile device 100. As another example, match quality for a given ad may be computed based on conformity in a specific subject category identified from state information acquired from mobile device 110. For example, the state information may indicate that mobile device 110 is presently visiting a restaurant website, causing advertising manager 320 to give particular influence to match quality in the restaurant subject category when selecting an ad. Moreover, in this example, the GPS component of state information may provide further fine-tuning and cause advertising manager 320 to give particular influence to match quality in the subcategory of restaurants in the vicinity of mobile device 110 or along a route that mobile device 110 is following. For even further fine-tuning, the trajectory of mobile device 110 along a route can be computed and applied to select an ad for a restaurant along the route that matches the trajectory. Relevancy scores for advertisements in different subject categories may be stored locally on advertising manager 320 or stored in advertisement store 220 and remotely accessed by advertising manager 320. Generally speaking, an ad having the highest match quality is selected. However, a compatible ad of lesser match quality may be selected in certain circumstances, for example, to avoid redundancy (e.g., avoid playing the same ad on output device 210 more than once in a short time period) or ensure selection of an ad that can be seamlessly inserted into an entertainment program playing on output device 120 (e.g., an ad having a duration that matches a duration of a program break in an entertainment program playing on output device 210).

Selected advertisements are played on output interface 330, which has a display screen for providing video output, speakers for providing audio output, or both. Advertisement selection and play may be synchronized to program breaks in an entertainment program being sourced by program source 230 and played on output interface 330. For example, advertising manager 320 may detect a digital marker in a radio or television program being streamed from program source 230 to output device 210 indicating the start of a program break and, upon detecting the digital marker, select one or more ads that are compatible with the personality and state of mobile device 110 and insert them into the program stream whereupon they are played on output interface 330. Once the program break is over, the entertainment program is allowed to resume play on output interface 330. Advertising manager 320 may learn the duration of the program break from an explicit indication of program break duration in the digital marker. Alternatively, advertising manager 320 may have access to an advance program script informing advertising manager 320 of the approximate time and duration of program breaks. In a further alternative, advertising manager 320 may detect a second digital marker indicating the end of the program break. Moreover, if there is a mismatch between the duration of the selected ads and the duration of a program break, advertising manager 320 may make timing adjustments to the program or the ads. In the foregoing manner, the present individually targeted advertising system exposes the user of mobile device 110 to individually targeted ads in a manner that is not highly disruptive to an entertainment program that the user may be presently enjoying.

In some embodiments, such as where output device 210 is an electronic billboard, output device 210 may not play entertainment programs on output interface 330. In those embodiments, advertising manager 320 may continuously select and output device 210 may continuously play on output interface 330 advertisements compatible with the personality and state of mobile device 110 while mobile device 110 is in output device coverage area 240.

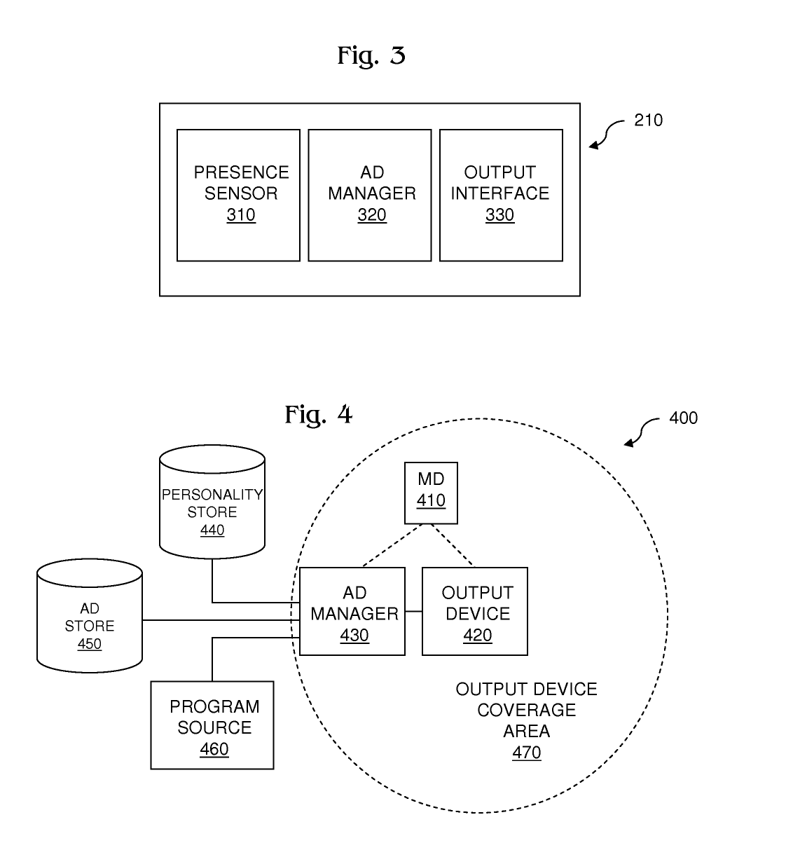

Turning to FIG. 4, an advertisement selection and output subsystem 400 within the system for individually targeted advertising is shown in a second embodiment. In subsystem 400, an output device 420 plays ads selected based on their compatibility with the personality of a mobile device 410 whose presence is detected in output device coverage area 470. An advertising manager 430 is also located in output device coverage area 470. However, in this embodiment, advertising manager 430 is a structurally separate and distinct entity from output device 420 that locally communicates with output device 420 over a wired or wireless connection and remotely communicates with a personality store 440, an advertisement store 450 and a program source 460. In operation, output device 420 locally acquires from mobile device 410 the unique MAI of mobile device 410 and relays the MAI to advertising manager 430. Advertising manager 430 uses the MAI to query mobile device 410 for information on the state of mobile device 410 and also uses the MAI to remotely access the personality of mobile device 410 stored in personality store 440. Advertising manager 430 then remotely accesses advertisement store 450, selects one or more advertisements compatible with the personality and state information acquired from mobile device 410 and causes the ads to be played on output device 420. Similar to subsystem 200, ad selection and play may be timed to correspond with program breaks in an entertainment program being sourced by program source 460 and played on output device 420.

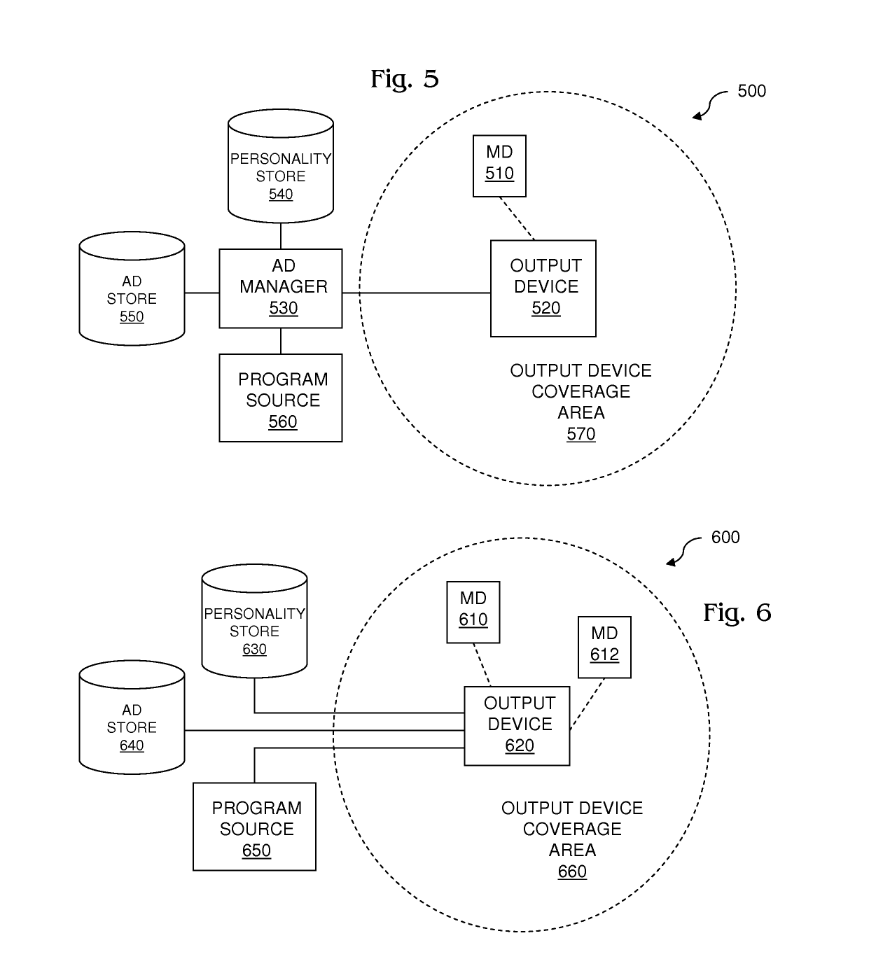

Referring to FIG. 5, an advertisement selection and output subsystem 500 within the system for individually targeted advertising is shown in a third embodiment. In subsystem 500, an output device 520 plays advertisements selected based on their compatibility with the personality of a mobile device 510 whose presence is detected in output device coverage area 570. Advertising manager 530 is a physically separate and distinct structure from output device 520. Moreover, in this embodiment, advertising manager 530 is located outside output device coverage area 570 and remotely communicates with output device 520. Output device 520 locally acquires from mobile device 510 the unique MAI of mobile device 510 and uses the MAI to query mobile device 510 for information on the state of mobile device 510. Output device 520 relays the MAI and the state information to advertising manager 530. Advertising manager 530 uses the MAI to access the personality of mobile device 510 stored in a personality store 540. Advertising manager 530 then accesses advertisement store 550, selects one or more advertisements compatible with the personality and state information acquired from mobile device 510 and causes the ads to be played on output device 520. Ad selection and play may once again be timed to correspond with program breaks in an entertainment program being sourced by program source 560 and played on output device 520.

Turning now to FIG. 6, an advertisement selection and output subsystem 600 within the system for individually targeted advertising is shown in a fourth embodiment. Subsystem 600 is identical to subsystem 200 (having elements 620, 630, 640 and 650 which correspond to elements 210, 140, 220 and 230 from FIG. 2) except for the concurrent presence of plural mobile devices 610, 612 within output device coverage area 660. In this embodiment, output device 620 detects the concurrent presence of mobile devices 610, 612 and, upon such detection, selects advertisements compatible with the personalities of mobile devices 610, 612 in accordance with a predetermined algorithm. In one possible algorithm, output device 620 selects individual ones of mobile devices 610, 612 in a round-robin sequence and selects a sequence of ads compatible with the personalities and states of the individually selected mobile device 610, 612. In another possible algorithm, output device 620 selects ads compatible with a composite personality of mobile devices 610, 612 determined by blending their individual personalities and states. In a third possible algorithm, output device 620 selects ads compatible with a personality of the one of mobile devices 610, 612 having a highest priority.

In the third algorithm, mobile devices 610, 612 may be prioritized based on different criteria, such as mobile device type (e.g., tablet computers may have a higher priority than smart phones, or vice versa), amount of influence of prior ads on the users of mobile devices 610, 612 (e.g., as determined by correlation of prior ads selected for mobile devices 610, 612 with the purchase histories of mobile devices 610, 612), and whether the users of mobile devices 610, 612 are or are not paying subscribers of the system. Priorities of mobile devices 610, 612 may be stored as part of their personality data sets in personality store 140 and accessed in conjunction with accessing the personalities.

It bears noting that the relative efficacy of the ad selection algorithms discussed above may depend on how many mobile devices are concurrently present in the output device coverage area. For example, at a bus stop where there two concurrently present mobile devices, the first algorithm (round-robin ad selection) may be preferred. However, in a sports bar where there are dozens of concurrently present mobile devices, the second algorithm (blended ad selection) may be preferred. Accordingly, in some embodiments, in response to detecting concurrent presence of mobile devices 610, 612 in output device coverage area 660, output device 620 chooses an ad selection algorithm from among multiple configured ad selection algorithms based on the number of concurrently present mobile devices.

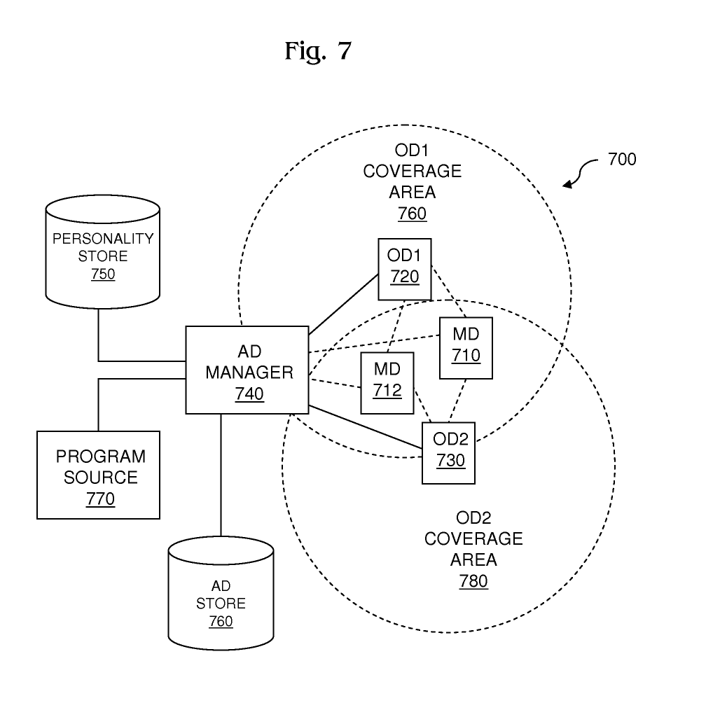

Referring now to FIG. 7, an advertisement selection and output subsystem 700 within the system for individually targeted advertising is shown in a fifth embodiment. In subsystem 700, advertising manager 740 interoperates with personality store 750, advertisement store 760 and program store 770 in a manner similar to prior embodiments. However, advertising manager 740 is responsible for managing ad selection for multiple output devices (OD1, OD2) 720, 730 having overlapping coverage areas 760, 770. When output devices 720, 730 detect concurrent presence of mobile devices 710, 712 in their respective coverage areas 760, 770 and report the MAIs of mobile devices 710, 712 to advertising manager 740, advertising manager 740 may treat output devices 720, 730 independently of one another and select advertisements for each of output devices 720, 730 without regard to the other output device. Alternatively, as there are two mobile devices 710, 712 sharing two output devices 720, 730, advertising manager 740 may dedicate one of output devices 720, 730 to each of mobile devices 710, 712 and select ads for output devices 720, 730 compatible with the personality of the mobile device to which they are dedicated.

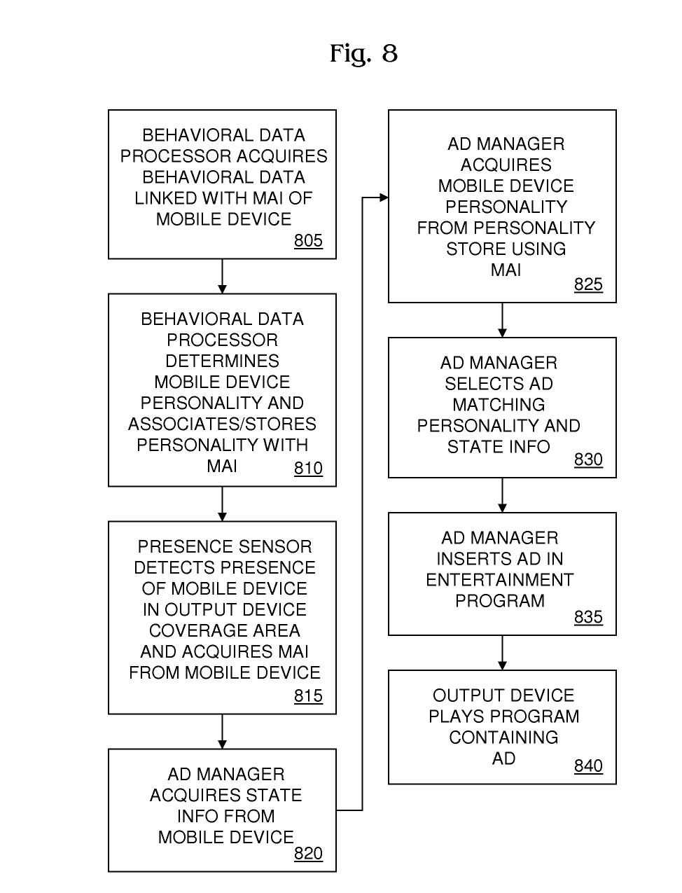

Turning now to FIG. 8, a method for individually targeted advertising is shown in some embodiments of the invention. The method will be described in conjunction with FIGS. 1-3. At the outset, behavioral data processor 120 acquires behavioral data linked with the unique MAI of mobile device 110 (805). Behavioral data processor 120 then determines the personality of mobile device 110 using the behavioral data and stores the personality in personality store 140 in association with the MAI (810). When mobile device 110 moves within range of output device 210, a presence sensor 310 on output device 210 detects the presence of mobile device 110 in output device coverage area 240 and acquires the MAI of mobile device 110 (815). Advertising manager 320 on output device 320 then acquires state information from mobile device 110 (820) and remotely accesses the personality of mobile device 110 from personality store 140 using the MAI as a lookup key (825). Advertising manager 320 then selects an advertisement in advertisement store 220 that matches the personality and state information (830) and seamlessly inserts the ad in an entertainment program being delivered to output device 210 (835) whereupon output device 210 plays the program containing the ad (840).

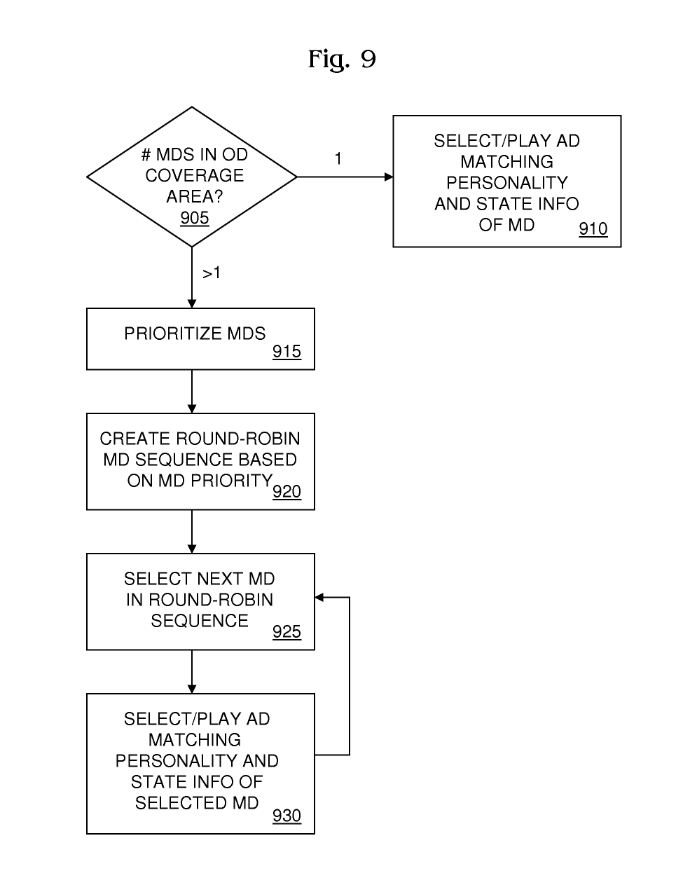

FIG. 9 shows a round-robin method for selecting advertisements during a period of concurrent presence of mobile devices in an output device coverage area. Concurrent presence of mobile devices is illustrated in FIGS. 6 and 7. At the outset, an advertising manager monitors the number of mobile devices (MDs) having MAIs present in an output device (OD) coverage area managed by the advertising manager (905). If there is just one mobile device present, the advertising manager selects and the output device plays an advertisement compatible with the personality and state information of the present mobile device (910). However, if there is more than one mobile device present, the advertising manager prioritizes the concurrently present mobile devices (915) and places them in a round-robin sequence based on priority (920). The advertising manager then selects the first mobile device in the round-robin sequence (925). The advertising manager then selects and the output device plays an advertisement based on compatibility with the personality and state information of the selected mobile device (930). If concurrent presence of the mobile devices persists, the advertising manager then selects the next mobile device in the round-robin sequence and the process is repeated.

In some embodiments, rather that a pure round-robin sequence, a priority-weighted sequence may be used wherein concurrently present mobile devices having higher priorities receive more turns in the sequence than those having lower priorities. This results in a higher share of ads compatible with the personalities and state information of higher priority mobile devices being selected and played without completely neglecting lower priority mobile devices.

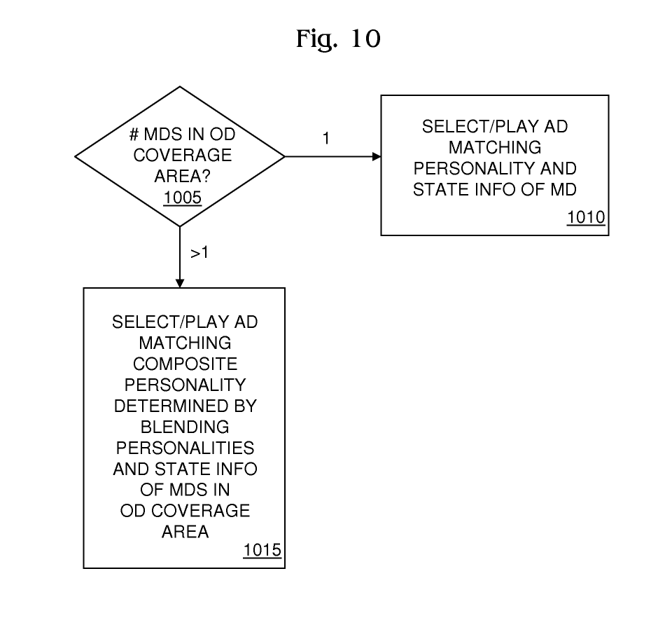

FIG. 10 shows a blending method for selecting advertisements during a period of concurrent presence of mobile devices in an output device coverage area. At the outset, an advertising manager monitors the number of mobile devices having MAIs present in an output device coverage area managed by the advertising manager (1005). If there is just one mobile device present, the advertising manager selects and the output device plays an advertisement compatible with the personality and state information of the present mobile device (1010). However, if there is more than one mobile device present, the advertising manager blends the individual personalities and states of all of the concurrently present mobile devices and selects ads compatible with a composite personality and state determined by blending the individual personalities and states (1015) while concurrent presence persists.

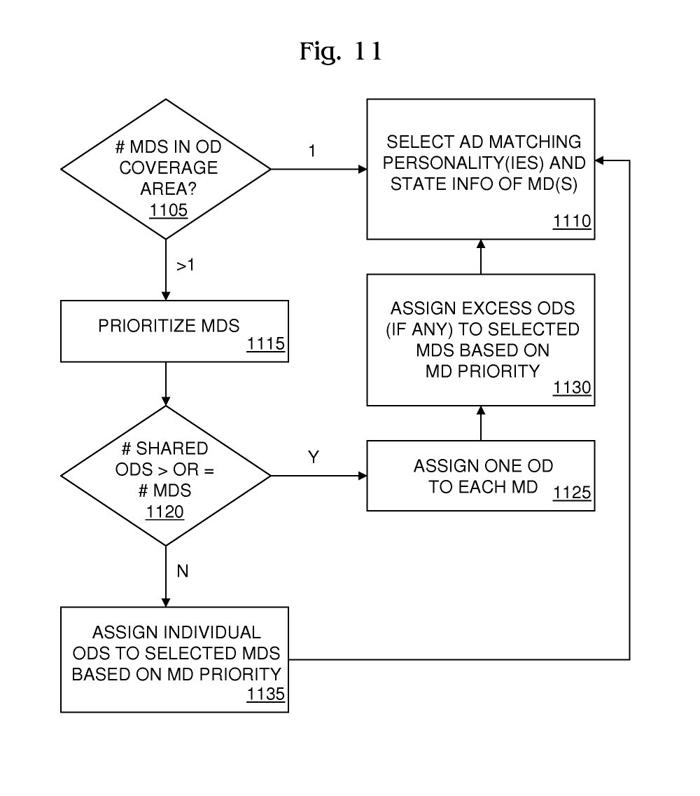

FIG. 11 shows a priority-based method for selecting advertisements during a period of concurrent presence of mobile devices within an output device coverage area. At the outset, an advertising manager monitors the number of mobile devices having MAIs present in an output device coverage area managed by the advertising manager (1105). If there is just one mobile device present, the advertising manager selects and the output device plays an advertisement compatible with the personality and state information of the present mobile device (1110). However, if there is more than one mobile device present, the advertising manager prioritizes the concurrently present mobile devices (1115). The advertising manager then determines whether these mobile devices are also concurrently present in the coverage areas of other output devices (1120). If the number of output device coverage areas in which these mobile devices are concurrently present is equal to or greater than the number of mobile devices, each of the mobile devices is assigned one of the output devices (1125), with any excess output devices being assigned to the mobile devices based on priority (1130). The advertising manager then selects and the output devices play advertisements compatible with the personalities and state information of the mobile devices to which the output devices are assigned (1110). On the other hand, if the number of output device coverage areas in which the mobile devices present in the initial coverage area are concurrently present is less than the number of mobile devices, the output devices are assigned to the individual mobile devices based on priority (1135).

In some embodiments, more than one of the behavioral data processor, personality store, advertising manager, advertisement store and program source are collocated at a site remote from the output device coverage area. In these embodiments, a completely or partially centralized head-end program/advertising service can deliver entertainment programming and individually targeted ads to a large number of geographically dispersed output devices.

In some embodiments, rather than being integral with the output device, the presence sensor is a physically separate and distinct structure installed near the output device that locally communicates with the output device over a wired or wireless connection. In these embodiments, a passive display terminal whose role in the system is merely to play entertainment programs and advertisements may be used as the output device.

In some embodiments, each mobile device has its own behavioral data processor and/or personality store. In these embodiments, each mobile device determines and/or stores its own personality as well as its state information, allowing devices within an output device coverage area involved in ad selection to access the personality without remote access.

In some embodiments, one or more users of mobile devices may allow their personal identities to be known to the system by making an “opt in” selection on their mobile device. This allows the behavioral data processor to collect behavioral data linked with the personal identities of these individuals (as well as behavioral data linked with MAIs) and possibly determine more exacting personalities for their mobile devices using this supplemental behavioral data.

In some embodiments, the behavioral data processor algorithmically analyzes the match quality of different personalities stored in the personality store and links personalities whose match quality exceeds a predetermined level on the thesis that mobile devices associated with highly correlated personalities are used by the same individual. In these embodiments, personalities stored in the personality store may include a “related MAI” field identifying MAIs of highly correlated personalities. When the advertising manager accesses one of the linked personalities in the personality store using the MAI of one of the mobile devices, the advertising manager discovers the related MAI and can use the related MAI, within its discretion, to acquire the personality associated with the related MAI and use it as a further consideration in advertisement selection.

It will be appreciated by those of ordinary skill in the art that the present description is merely illustrative and not restrictive and that the invention may be embodied in other forms without departing from its spirit or essential character. The scope of the invention is indicated by the appended claims, and all changes that come with in the meaning and range of equivalents thereof are intended to be embraced therein.

What is claimed is:

1. A system for individually targeted advertising, comprising:
a mobile device personality determination subsystem configured to acquire behavioral data linked with a mobile device, determine a personality of the mobile device using the behavioral data and store the personality; and
an advertisement selection and output subsystem configured to detect presence of the mobile device in a coverage area of an output device and, in response to detecting presence of the mobile device in the coverage area, access the stored personality, select an advertisement based on compatibility of the advertisement with the personality and play the advertisement on the output device.

2. The system of claim 1, wherein the acquired behavioral data and the stored personality are linked with a unique mobile advertising identifier (MAI) of the mobile device, wherein the MAI is transferred from the mobile device to a presence sensor associated with the output device while the mobile device is present in the coverage area and wherein the stored personality is accessed using the MAI.

3. The system of claim 2, wherein the MAI is a special purpose identifier dedicated for use in the system.

4. The system of claim 2, wherein the MAI is a Bluetooth device address.

5. The system of claim 2, wherein the MAI is a media access control (MAC) address.

6. The system of claim 1, wherein presence of the mobile device is detected based on strength of wireless communication between the mobile device and a presence sensor associated with the output device.

7. The system of claim 1, wherein presence of the mobile device is detected based on a geolocation of the mobile device reported by the mobile device to a presence sensor associated with the output device.

8. The system of claim 1, wherein presence of the mobile device is detected based on an optical signal transmitted by the mobile device to a presence sensor associated with the output device.

9. The system of claim 1, wherein presence of the mobile device is detected based on an acoustic signal transmitted by the mobile device to a presence sensor associated with the output device.

10. The system of claim 1, wherein presence of the mobile device is detected using an indoor positioning system (IPS).

11. The system of claim 10, wherein the IPS is an acoustic IPS.

12. The system of claim 10, wherein the IPS is an optical IPS.

13. The system of claim 10, wherein the IPS is a wireless networking IPS.

14. The system of claim 1, wherein the advertisement selection and output subsystem is further configured, in response to detecting presence of the mobile device in the coverage area, to acquire state information from the mobile device, wherein the advertisement is further selected based on compatibility of the advertisement with the state information.

15. The system of claim 1, wherein the acquired behavioral data comprises data acquired from the mobile device.

16. The system of claim 1, wherein the acquired behavioral data comprises data acquired from sources with which the mobile device has transacted.

17. The system of claim 16, wherein the sources include an Internet service provider from which the mobile device has received Internet service.

18. The system of claim 16, wherein the sources include a television service provider from which mobile device has received television service.

19. The system of claim 16, wherein the sources include a merchant with which mobile device has transacted.

20. The system of claim 16, wherein the sources include an Internet radio service provider from which mobile device has received radio service.

21. The system of claim 1, wherein the advertisement is selected based on a match quality between the advertisement and the personality.

22. The system of claim 14, wherein the advertisement is selected based on a match quality between the advertisement, on the one hand, and the personality and state information, on the other.

23. The system of claim 1, wherein the advertisement selection and output subsystem is further configured to insert the advertisement at a program break in an entertainment program being played on the output device.

24. The system of claim 1, wherein the system is configured to operate transparently to any user of the mobile device.

25. The system of claim 1, wherein the system is configured to operate without intervention by any user of the mobile device.

26. The system of claim 1, wherein the system is configured to operate without using any personal identity of any user of the mobile device.

27. The system of claim 1, wherein the mobile device is a smart phone.

28. The system of claim 1, wherein the mobile device is a passenger vehicle.

29. The system of claim 1, wherein the mobile device is a tablet computer.

30. The system of claim 1, wherein the output device is a television set.

31. The system of claim 1, wherein the output device is a radio player.

32. The system of claim 1, wherein the output device is a digital sign.

33. The system of claim 1, wherein the output device is a movie theater screen.

34. A system for individually targeted advertising, comprising:
a mobile device personality determination subsystem configured to acquire behavioral data linked with a plurality of mobile devices, determine personalities of the respective mobile devices using the acquired behavioral data and store the respective personalities; and
an advertisement selection and output subsystem configured to detect concurrent presence of the mobile devices in a coverage area of an output device and, in response to detecting concurrent presence of the mobile devices in the coverage area, access the stored personalities of the mobile devices, select a sequence of advertisements based on compatibility of the advertisements with the personalities of individual ones of the mobile devices selected in a round-robin sequence and play the sequence of advertisements on the output device.

35. The system of claim 34, wherein the acquired behavioral data and the stored personalities are linked with unique mobile advertising identifiers (MAIs) of the mobile devices, wherein the MAIs are transferred from the mobile devices to a presence sensor associated with the output device while the mobile devices are present in the coverage area and wherein the stored personalities are accessed using the MAIs.

36. A system for individually targeted advertising, comprising:
a mobile device personality determination subsystem configured to acquire behavioral data linked with a plurality of mobile devices, determine personalities of the respective mobile devices using the acquired behavioral data and store the respective personalities; and
an advertisement selection and output subsystem configured to detect concurrent presence of the mobile devices in a coverage area of an output device and, in response to detecting concurrent presence of the mobile devices in the coverage area, access the stored personalities of the mobile devices, select an advertisement based on compatibility of the advertisement with a composite personality determined by blending the personalities of the mobile devices and play the advertisement on the output device.

37. The system of claim 36, wherein the acquired behavioral data and the stored personalities are linked with unique mobile advertising identifiers (MAIs) of the mobile devices, wherein the MAIs are transferred from the mobile devices to a presence sensor associated with the output device while the mobile devices are present in the coverage area and wherein the stored personalities are accessed using the MAIs.

38. A system for individually targeted advertising, comprising:
a mobile device personality determination subsystem configured to acquire behavioral data linked with a plurality of mobile devices, determine personalities of the respective mobile devices using the acquired behavioral data and store the respective personalities; and
an advertisement selection and output subsystem configured to detect concurrent presence of the mobile devices in a coverage area of an output device and, in response to detecting concurrent presence of the mobile devices in the coverage area, access the stored personalities of the mobile devices, determine one of the mobile devices having a highest priority, select an advertisement based on compatibility of the advertisement with the personality of the one of the mobile devices having the highest priority and play the advertisement on the output device.

39. The system of claim 38, wherein the acquired behavioral data and the stored personalities are linked with unique mobile advertising identifiers (MAIs) of the mobile devices, wherein the MAIs are transferred from the mobile devices to a presence sensor associated with the output device while the mobile devices are present in the coverage area and wherein the stored personalities are accessed using the MAIs.

40. A method for individually targeted advertising, comprising:
acquiring behavioral data linked with a mobile device;
determining a personality of the mobile device using the behavioral data;
storing the personality;
detecting presence of the mobile device in a coverage area of an output device; and, in response to detecting presence of the mobile device in the coverage area,
accessing the stored personality;
selecting an advertisement based on compatibility of the advertisement with the personality; and
playing the advertisement on the output device.

41. The method of claim 40, wherein the acquired behavioral data and the stored personality are linked with a unique mobile advertising identifier (MAI) of the mobile device, wherein the MAI is transferred from the mobile device to a presence sensor associated with the output device while the mobile device is present in the coverage area and wherein the stored personality is accessed using the MAI.
